(19) United States
(12) Patent Application Publication
(10) Pub. No.: US 2021/0232340 A1
(43) Pub. Date: Jul. 29, 2021

(54) DRIVE RECORDER AND DATA RECORDING METHOD

(71) Applicant: Panasonic Intellectual Property Management Co., Ltd., Osaka (JP)

(72) Inventors: Yoshiki ITO, Osaka (JP); Kenji MATSUI, Osaka (JP); Seigo TAKADA, Osaka (JP); Kazuomi KATO, Kyoto (JP)

(73) Assignee: Panasonic Intellectual Property Management Co., Ltd., Osaka (JP)

(21) Appl. No.: 17/157,082

(22) Filed: Jan. 25, 2021

(30) Foreign Application Priority Data
Jan. 29, 2020 (JP) 2020-012141

(51) Int. Cl. G06F 3/06; H04N 7/18; G08B 21/18

(52) U.S. Cl. CPC G06F 3/0659; G06F 3/0604; G08B 21/182; G06F 3/0653; H04N 7/183; G06F 3/067

(57) ABSTRACT

A drive recorder transmits, to a server device, a moving image file showing status of surroundings of a vehicle at the time of generation of a large acceleration. The server device determines whether overwrite prohibition is to be designated for the moving image file that shows surroundings of the vehicle at the time of an occurrence of an event, based on the moving image file. The drive recorder designates, based on a determination result, overwrite prohibition for a piece of video data showing surroundings of the vehicle at the time of and/or before and after the occurrence of the event, and counts the number of pieces of video data for which overwrite prohibition is designated.

### CROSS REFERENCE TO RELATED APPLICATION

The present application is based on and claims priority of Japanese Patent Application No. 2020-012141 filed on Jan. 29, 2020.

### FIELD

The present disclosure relates to a technique for processing a moving image recorded in a mobile body.

### BACKGROUND

Conventionally, drive recorders that capture views ahead of vehicles and cyclically record, on a memory, pieces of video data obtained by capturing the views have been known (for example, Patent Literature (PTL) 1). In response to the generation of a large acceleration due to, for example, harsh braking, the drive recorders prohibit overwriting of a piece of video data in which a period of time before and after the generation of the large acceleration is recorded, and uses the video for a subsequent investigation (for example, PTL 2).

In addition, a recording area in which overwriting is prohibited is limited to a certain extent to reserve an area for cyclically recorded pieces of video data. For this reason, even if a piece of video data is prohibited from being overwritten, the piece of video data is further overwritten with another piece of video data generated at the time at which a larger acceleration has generated.

### CITATION LIST

### Patent Literature

PTL 1: Japanese Unexamined Patent Application Publication No. 2013-182573

PTL 2: Japanese Unexamined Patent Application Publication No. 2012-048606

### SUMMARY

However, there is room for improvement in the drive recorder or data recording method according to PTL 1 or PTL 2.

In view of the above, the present disclosure provides a drive recorder or a data recording method capable of contributing to further improvement.

In order to provide such a drive recorder, a drive recorder according to the present disclosure is a drive recorder that records, in a temporally continuous manner, a piece of video data showing surroundings of a vehicle on a recording medium. The drive recorder includes: an obtaining means for obtaining the piece of video data; a recording means for recording a new piece of video data on the recording medium by overwriting, with the new piece of video data, an other piece of video data among a plurality of pieces of video data which have been recorded on the recording medium, the other piece of video data being data for which overwrite prohibition is not designated; a detecting means for detecting an occurrence of an event; a transmitting means for transmitting, to an external device, a piece of status data indicating status at a time of and/or before and after the occurrence of the event; a receiving means for receiving, from the external device, a determination result obtained by the external device determining, based on the piece of status data, whether the overwrite prohibition is designated for a piece of event video data, the piece of event video data being the piece of video data showing surroundings of the vehicle at the time of and/or before and after the occurrence of the event; a prohibiting means for designating, based on the determination result, the overwrite prohibition for the piece of event video data; and a counting means for counting a total number of pieces of event video data for which overwrite prohibition is designated by the prohibiting means.

In addition, a drive recorder according to the present disclosure is a drive recorder that records, in a temporally continuous manner, a piece of video data showing surroundings of a vehicle on a recording medium. The drive recorder includes: an obtaining means for obtaining the piece of video data; a recording means for recording a new piece of video data on the recording medium by overwriting, with the new piece of video data, an other piece of video data among a plurality of pieces of video data which have been recorded on the recording medium, the other piece of video data being data for which overwrite prohibition is not designated; a detecting means for detecting an occurrence of an event; a transmitting means for transmitting, to an external device, a piece of status data indicating status at a time of and/or before and after the occurrence of the event; a receiving means for receiving, from the external device, a determination result obtained by the external device determining, based on the piece of status data, whether the overwrite prohibition is designated for a piece of event video data, the piece of event video data being the piece of video data showing surroundings of the vehicle at the time of and/or before and after the occurrence of the event; a prohibiting means for designating, based on the determination result, the overwrite prohibition for the piece of event video data; and a notifying means for providing a user with a notification when a total number of pieces of event video data for which overwrite prohibition is designated by the prohibiting means exceeds a predetermined threshold.

In addition, a data recording method according to the present disclosure is a data recording method for recording, in a temporally continuous manner, a piece of video data showing surroundings of a vehicle on a recording medium. The data recording method includes: (a) obtaining the piece of video data; (b) recording a new piece of video data obtained in (a) on the recording medium by overwriting, with the new piece of video data, an other piece of video data among a plurality of pieces of video data which have been recorded on the recording medium, the other piece of video data being data for which overwrite prohibition is not designated; (c) detecting an occurrence of an event; (d) transmitting, to an external device, a piece of status data indicating status at a time of and/or before and after the occurrence of the event; (e) receiving, from the external device, a determination result obtained by the external device determining, based on the piece of status data, whether the overwrite prohibition is designated for a piece of event video data, the piece of event video data being the piece of video data showing surroundings of the vehicle at the time of and/or before and after the occurrence of the event;

(f) designating, based on the determination result, overwrite prohibition for the piece of event video data; and (g) counting a total number of pieces of event video data for which overwrite prohibition is designated in the designating.

Note that these general or specific aspects may be implemented using a system, a method, an integrated circuit, a computer program, or a computer-readable recording medium such as a CD-ROM, or any optional combination of systems, methods, integrated circuits, computer programs, or computer-readable recoding media. In addition, the computer-readable recording medium may be a non-transitory computer-readable recording medium.

A drive recorder or a data recording method according to an aspect of the present disclosure can contribute to further improvement.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 illustrates an overview of a data recording system.

FIG. 2 illustrates a configuration of a drive recorder.

FIG. 3 illustrates a configuration of a server device.

FIG. 4 illustrates an array structure of moving image files in a recorder.

FIG. 5 illustrates an example of a status file.

FIG. 6 illustrates an example of an overwrite prohibition list.

FIG. 7 illustrates steps of processing performed by the drive recorder.

FIG. 8 illustrates steps of processing performed by the drive recorder.

FIG. 9 illustrates steps of processing performed by the drive recorder.

FIG. 10 illustrates steps of processing performed by the server device.

FIG. 11 illustrates an example of a data recording system according to a variation.

FIG. 12 illustrates an example of a notification provided for a user.

### DESCRIPTION OF EMBODIMENTS

### (Underlying Knowledge Forming Basis of Present Disclosure)

The inventor of the present disclosure has found out that the techniques presented in Background causes the following problems.

Conventionally, drive recorders that capture views ahead of vehicles and cyclically record, on a memory, pieces of video data obtained by capturing the views have been known (for example, Patent Literature (PTL) 1). In response to the generation of a large acceleration due to, for example, harsh braking, the drive recorders prohibit overwriting of a piece of video data in which a period of time before and after the generation of the large acceleration is recorded, and uses the video for a subsequent investigation (for example, PTL 2).

In addition, a recording area in which overwriting is prohibited is limited to a certain extent to reserve an area for cyclically recorded pieces of video data. For this reason, even if a piece of video data is prohibited from being overwritten, the piece of video data is further overwritten with another piece of video data generated at the time at which a larger acceleration has generated.

However, among traffic accidents caused by vehicles, there are traffic accidents where the generated acceleration is not large since a driver did not slam on the brakes. In such a case, even if the instant of a traffic accident etc. are recorded in a piece of video data, the piece of video data will be overwritten with another piece of video data generated at the time at which a larger acceleration has generated. Accordingly, the piece of video data cannot be used for a subsequent investigation, and this will cause a problem.

In addition, even if the generated acceleration is large, there may be a case in which a piece of video data may not contribute in any way for the investigation due to camera attachment failure. If the piece of video data in such a case is prohibited from being overwritten, a limited recording area will be occupied by useless pieces of data, and this will cause a problem.

Furthermore, since the recording area has a limited capacity, the recording area will be filled to capacity if many pieces of data are prohibited from being overwritten. Accordingly, a new piece of data cannot be recorded, and this will cause a problem.

In view of the above, the present disclosure aims to provide a technique for appropriately recording pieces of video data.

In order to provide such a technique, a drive recorder according to an aspect of the present disclosure is a drive recorder that records, in a temporally continuous manner, a piece of video data showing surroundings of a vehicle on a recording medium. The drive recorder includes: an obtaining means for obtaining the piece of video data; a recording means for recording a new piece of video data on the recording medium by overwriting, with the new piece of video data, an other piece of video data among a plurality of pieces of video data which have been recorded on the recording medium, the other piece of video data being data for which overwrite prohibition is not designated; a detecting means for detecting an occurrence of an event; a transmitting means for transmitting, to an external device, a piece of status data indicating status at a time of and/or before and after the occurrence of the event; a receiving means for receiving, from the external device, a determination result obtained by the external device determining, based on the piece of status data, whether the overwrite prohibition is designated for a piece of event video data, the piece of event video data being the piece of video data showing surroundings of the vehicle at the time of and/or before and after the occurrence of the event; a prohibiting means for designating, based on the determination result, the overwrite prohibition for the piece of event video data; and a counting means for counting a total number of pieces of event video data for which overwrite prohibition is designated by the prohibiting means.

With this, it may be possible to certainly prohibit overwriting of a piece of video data that is to be prohibited from being overwritten.

For example, the drive recorder may further include a notifying means for providing a user with a notification when the total number counted by the counting means exceeds a predetermined threshold.

With this, a user is provided with a notification when a recording area is filled to capacity. Therefore, it is possible to prevent a state in which a new piece of data that is to be prohibited from being overwritten cannot be recorded.

For example, the notifying means may provide the user with a notification when the total number counted exceeds the predetermined threshold and a predetermined condition is satisfied.

For example, after providing the user with the notification, the notifying means may provide the user with another notification when a predetermined condition specified subsequent to the predetermined condition is satisfied.

For example, the drive recorder may further include a data migrating means for transferring a piece of event video data for which the overwrite prohibition is designated from a recording area in which the piece of event video data is recorded to a different recording area, when the total number counted by the counting means reaches a certain number.

In addition, a drive recorder according to an aspect of the present disclosure is a drive recorder that records, in a temporally continuous manner, a piece of video data showing surroundings of a vehicle on a recording medium. The drive recorder includes: an obtaining means for obtaining the piece of video data; a recording means for recording a new piece of video data on the recording medium by overwriting, with the new piece of video data, an other piece of video data among a plurality of pieces of video data which have been recorded on the recording medium, the other piece of video data being data for which overwrite prohibition is not designated; a detecting means for detecting an occurrence of an event; a transmitting means for transmitting, to an external device, a piece of status data indicating status at a time of and/or before and after the occurrence of the event; a receiving means for receiving, from the external device, a determination result obtained by the external device determining, based on the piece of status data, whether the overwrite prohibition is designated for a piece of event video data, the piece of event video data being the piece of video data showing surroundings of the vehicle at the time of and/or before and after the occurrence of the event; a prohibiting means for designating, based on the determination result, the overwrite prohibition for the piece of event video data; and a notifying means for providing a user with a notification when a total number of pieces of event video data for which overwrite prohibition is designated by the prohibiting means exceeds a predetermined threshold.

Moreover, a data recording method according to an aspect of the present disclosure is a data recording method for recording, in a temporally continuous manner, a piece of video data showing surroundings of a vehicle on a recording medium. The data recording method includes: (a) obtaining the piece of video data; (b) recording a new piece of video data obtained in (a) on the recording medium by overwriting, with the new piece of video data, an other piece of video data among a plurality of pieces of video data which have been recorded on the recording medium, the other piece of video data being data for which overwrite prohibition is not designated; (c) detecting an occurrence of an event; (d) transmitting, to an external device, a piece of status data indicating status at a time of and/or before and after the occurrence of the event; (e) receiving, from the external device, a determination result obtained by the external device determining, based on the piece of status data, whether the overwrite prohibition is designated for a piece of event video data, the piece of event video data being the piece of video data showing surroundings of the vehicle at the time of and/or before and after the occurrence of the event; (f) designating, based on the determination result, overwrite prohibition for the piece of event video data; and (g) counting a total number of pieces of event video data for which overwrite prohibition is designated in the designating.

With this, the data recording method produces the same advantageous effects as the above-described drive recorder.

Hereinafter, embodiments will be described in detail with reference to the drawings.

Note that the embodiments below each describe a general or specific example. The numerical values, shapes, materials, elements, the arrangement and connection of the elements, steps, order of the steps, etc. indicated in the following embodiments are mere examples, and therefore are not intended to limit the scope of the present disclosure. Therefore, among the elements in the following embodiments, elements not recited in any of the independent claims defining the most generic part of the present disclosure are described as optional elements. Note that the drawings are schematic diagrams, and do not necessarily provide strictly accurate illustration. Throughout the drawings, the same sign is given to substantially the same element.

Hereinafter, embodiments will be described in detail with reference to the drawings.

Note that the embodiments below each describe a general or specific example. The numerical values, shapes, materials, elements, the arrangement and connection of the elements, steps, order of the steps, etc. indicated in the following embodiments are mere examples, and therefore are not intended to limit the scope of the present disclosure. Therefore, among the elements in the following embodiments, elements not recited in any of the independent claims defining the most generic part of the present disclosure are described as optional elements. Note that the drawings are schematic diagrams, and do not necessarily provide strictly accurate illustration. Throughout the drawings, the same sign is given to substantially the same element.

### EMBODIMENTS

Hereinafter, an embodiment of the present disclosure will be described with reference to the drawings.

### 1. Embodiment 1

### [1-1. Outline]

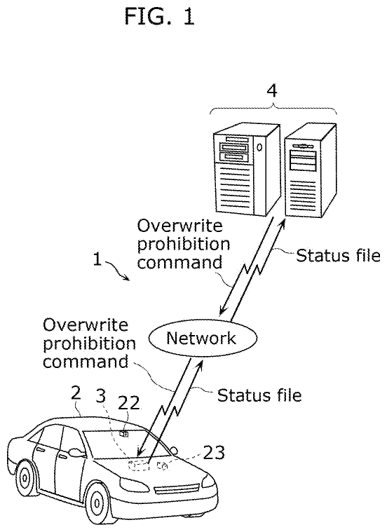

FIG. 1 illustrates an overview of data recording system 1. Data recording system 1 includes drive recorder 3 provided in vehicle 2, and server device 4 provided outside vehicle 2.

Vehicle 2 includes camera 22 that captures views ahead of vehicle 2, and acceleration sensor 23 that detects the acceleration generated in vehicle 2. Camera 22 and acceleration sensor 23 are connected with drive recorder 3.

Drive recorder 3 successively records, on a memory, moving image files obtained by camera 22 capturing views while an activation switch (e.g., an accessory switch (ACC)) of vehicle 2 is turned on. A moving image of about 10 second length is inputted into one file. When moving image files are recorded in the entire recording area in the memory, the latest moving image file overwrites the least recently recorded moving image file.

When a large acceleration (the so-called “event”) due to, for example, harsh braking or a collision generates in vehicle 2, this generation of acceleration serves as the impetus (the so-called “trigger”) to (i) prohibit overwriting of a moving image file in which a period of several tens of seconds before and after the generation of the acceleration is captured and (ii) store the moving image file. The moving image file is stored after the moving image file is prohibited from being overwritten. This is for a subsequent investigation into a cause of the generation of the acceleration.

However, a memory space in which the moving image file that is to be prohibited from being overwritten is recorded is limited to a fixed capacity. This is to prevent the entire memory space from being recorded by moving image files that are prohibited from being overwritten.

Consequently, only moving image files that should truly be prohibited from being overwritten are to be prohibited from being overwritten. Accordingly, it is desirable to examine the contents of a moving image, instead of merely considering the generation of acceleration as a factor in prohibiting a moving image from being overwritten. In other words, when no situation to be investigated in any way is captured in a stored moving image, even if a large acceleration has generated, there is no need for prohibiting overwriting of the stored moving image. Moreover, the limited memory space would be consumed by useless moving image files. On the contrary, a moving image in which the instant of a collision is captured is extremely important for a subsequent investigation, even if the generated acceleration is not large.

Drive recorder 3 according to the embodiment transmits, with the generation of a certain magnitude of acceleration as impetus, a moving image file obtained by capturing views before and after the generation of acceleration to server device 4 via a network. At this time, drive recorder 3 transmits, in addition to the moving image files, a status file into which pieces of data about occurrences, such as acceleration, happened in vehicle 2 are inputted. Server device 4 analyzes the moving images transmitted from drive recorder 3, and determines whether the moving images includes a video on which the instant of a collision etc. are captured. In other words, server device 4 determines whether the moving images are to truly be prohibited from being overwritten. When server device 4 determines that a moving image is to be prohibited from being overwritten, server device 4 transmits an overwrite prohibition command to drive recorder 3.

When drive recorder 3 receives the overwrite prohibition command, drive recorder 3 prohibits overwriting of a corresponding moving image file and stores the moving image file. With this, only moving image files that are to truly be prohibited from being overwritten are to be prohibited from being overwritten. In addition, since a moving image analysis that requires large amounts of computations is performed by server device 4, which is a large-scale arithmetic device, it is possible to readily and accurately determine the necessity of overwrite prohibition. The processing power of an arithmetic device provided in drive recorder 3 is typically not high, and thus a moving image analysis cannot be readily performed. Therefore, it is desirable for server device 4, which is a large-scale arithmetic device, to perform image recognition processing on a moving image obtained by drive recorder 3. Note that acceleration generated in vehicle 2 may be hereafter referred to as a “G value.”

### [1-2. Configuration]

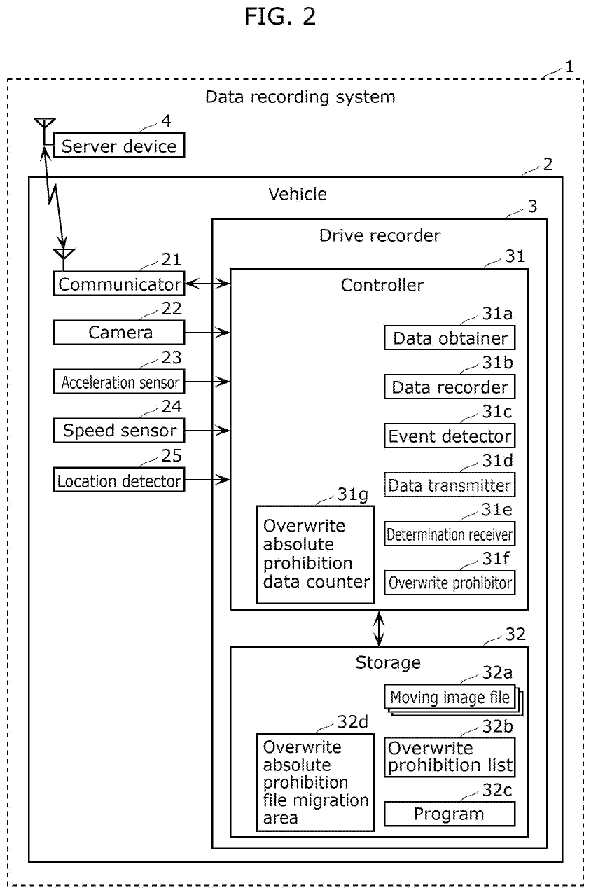

FIG. 2 illustrates a configuration of drive recorder 3. Drive recorder 3 is provided in vehicle 2, which is included in data recording system 1, and includes controller 31 and storage 32. In addition, vehicle 2 that includes drive recorder 3 is provided with communicator 21, camera 22, acceleration sensor 23, speed sensor 24, and location detector 25. Drive recorder 3 is connected with each of communicator 21, camera 22, acceleration sensor 23, speed sensor 24, and location detector 25.

Controller 31 is a microcomputer that includes a central processing unit (CPU), random-access memory (RAM), and read-only memory (ROM). Controller 31 controls the entirety of drive recorder 3. Functions that controller 31 perform will be described later.

Storage 32 is a storage medium (or recording medium) which stores (or records) data. For example, storage 32 is non-volatile memory, such as electrically erasable programmable read-only memory (EEPROM), flash memory, and a hard disk drive that includes a magnetic disk. Storage 32 stores moving image files 32a, overwrite prohibition list 32b, and program 32c. Storage 32 also includes, in a portion of storage 32, overwrite absolute prohibition file migration area 32d.

Moving image file 32a is digital audio tape (DAT)-type moving image data which is generated based on a plurality of pieces of still image data captured by camera 22 in a predetermined cycle. Storage 32 stores a plurality of moving image files 32a. For example, storage 32 stores 3000 files. A piece of moving image data of 10 second length is inputted into one file. An array structure of moving image file 32a in storage 32 will be described later in detail. Note that moving image file 32a includes a piece of audio data besides a piece of moving image data, and includes a signal for synchronizing the piece of moving image data and the piece of audio data. In addition, moving image file 32a functions as a piece of video data in the present disclosure. Note that when a piece of video data in the present disclosure indicates a single piece of or a plurality of pieces of still image data, it is desirable that the single piece of or the plurality of pieces of still image data indicate a piece of or the plurality of pieces of still image data in which around the time at which a G value increases or decreases the most is captured. This is because the time at which a G value increases or decreases the most is considered to most clearly display the characteristics of an occurrence happened in vehicle 2.

Overwrite prohibition list 32b is a data table in the form of a matrix. Overwrite prohibition list 32b includes an address where a moving image file that is prohibited from being overwritten is recorded, an overwrite prohibition type (absolute prohibition or general prohibition), and a G value generated during capturing views. By referring to overwrite prohibition list 32b, it is possible to recognize an address, an overwrite prohibition type, and the magnitude of a G value generated during capturing views. The configuration of overwrite prohibition list 32b will be described later in detail.

Program 32c is firmware read by controller 31. Controller 31 executes program 32c for controlling drive recorder 3. Note that program 32c is inputted into and outputted from drive recorder 3 via a storage medium, such as a memory card, or via an external device connected by a line. Note that program 32c may be stored, in advance, in the above-described RAM included in controller 31.

Overwrite absolute prohibition file migration area 32d is a storage area to which moving image file 32a whose overwrite prohibition type is designated as “overwrite absolute prohibition” migrates.

Next, each of the functions performed by the above-mentioned controller 31 will be described. Controller 31 includes data obtainer 31a, data recorder 31b, event detector 31c, data transmitter 31d, determination receiver 31e, overwrite prohibitor 31f, and overwrite absolute prohibition data counter 31g. Functions performed by respective units are implemented by controller 31 executing program 32c.

Data obtainer 31a obtains pieces of still image data from camera 22, and generates a moving image file. Data obtainer 31a also obtains a piece of acceleration data from acceleration sensor 23, a piece of speed data from speed sensor 24, a piece of location data from location detector 25, and an address of the moving image file from storage 32 to generate a status file including the moving image file. Accordingly, a status file includes the moving image file, and at least one of acceleration, speed, a location, and an address. Note that data obtainer 31a functions as an obtaining means in the present disclosure. In addition, a status file function as, in the present disclosure, a piece of status data indicating status at the time of and/or before and after an occurrence of an event.

Data recorder 31b records the moving image file generated by data obtainer 31a at an address which is not prohibited from being overwritten in storage 32. Note that data recorder 31b functions as a recording means in the present disclosure.

Event detector 31c computes a G value generated in vehicle 2, based on the piece of acceleration data transmitted from acceleration sensor 23. Then, event detector 31c compares the G value to a predetermined threshold, and detects whether an event that causes the moving image file to be prohibited from being overwritten has occurred. That is, when the generated G value exceeds a threshold, it is determined that the event has occurred. Note that the event may be any occurrences that happen to vehicle 2. For example, the event may be the generation of a G value that exceeds a certain magnitude, an occurrence of a collision, a sudden decrease in speed, inflation of an airbag, and approach of an object. Note that event detector 31c functions as an event detecting means in the present disclosure.

Data transmitter 31d transmits the status file generated by data obtainer 31a to server device 4 via communicator 21. The status file transmitted includes pieces of data about vehicle 2 which are generated at the time of and/or before and after an occurrence of an event. By transmitting, through the status file, the pieces of data generated at the time of and/or before and after an occurrence of an event, it is possible to examine, in detail, occurrences that have happened in vehicle 2. Note that data transmitter 31d functions as a transmitting means in the present disclosure.

Determination receiver 31e receives a signal transmitted from server device 4 to drive recorder 3. Particularly, determination receiver 31e receives an overwrite prohibition command that is a determination result indicating whether a specific moving image file is to be prohibited from being overwritten. Note that determination receiver 31e functions as a receiving means in the present disclosure.

Overwrite prohibitor 31f prohibits overwriting of a moving image file generated at the time of and/or before and after an occurrence of an event. Overwrite prohibitor 31f implements prohibition of overwriting by performing flag operation on a recording area in storage 32. That is, overwrite prohibitor 31f prohibits overwriting of a moving image file recorded at a corresponding address by setting an overwrite prohibition flag to ON, and in contrast, overwrite prohibitor 31f resets the prohibition of overwriting by setting the overwrite prohibition flag to OFF. In addition, overwrite prohibitor 31f absolutely prohibits, based on an overwrite prohibition command received by determination receiver 31e, overwriting of a moving image file specified in the overwrite prohibition command. Overwrite prohibitor 31f updates a corresponding section in an overwrite prohibition list to designate overwrite absolute prohibition for the moving image file specified. Once the moving image file is absolutely prohibited from being overwritten, the moving image file will not be overwritten by a moving image file subsequently generated at the time at which a greater G value has generated. This is because the moving image file is prohibited from being overwritten as a result of analyzing a content of the moving image, and thus the moving image file is extremely important for a subsequent investigation. Note that overwrite prohibitor 31f functions as a prohibiting means in the present disclosure.

Overwrite absolute prohibition data counter 31g counts the number of files for which overwrite absolute prohibition is designated by overwrite prohibitor 31f.

Next, each of elements provided in vehicle 2 will be described. Communicator 21 is a communication device that transmits a piece of data to and receives a piece of data from server device 4 via a network. For example, communicator 21 is a wireless communication device using, for example, worldwide interoperability for microwave access (WiMAX) or long term evolution (LTE).

Camera 22 is provided inside vehicle 2, and has an optical axis directed toward the front of vehicle 2. Camera 22 is activated in response to the turning on of an activation switch (e.g., an accessory switch (ACC)) of vehicle 2, and continually captures views ahead of vehicle 2. A plurality of pieces of still image data obtained by camera 22 capturing the views are transmitted to drive recorder 3. Drive recorder 3 generates a moving image file based on the plurality of pieces of still image data transmitted from camera 22.

Acceleration sensor 23 is a three-axis acceleration sensor that measures acceleration which generates in the front-rear direction, the left-right direction, and the up-down direction relative to vehicle 2. Acceleration sensor 23 measures acceleration generated in vehicle 2, and then transmits a piece of acceleration data to drive recorder 3.

Speed sensor 24 is a sensor that obtains the speed of vehicle 2. Speed sensor 24 obtains the speed of vehicle 2, and then transmits a piece of speed data to drive recorder 3.

Location detector 25 is a device that detects the current location of vehicle 2, using a satellite navigation system, such as a global positioning system (GPS). Location detector 25 detects the current location of vehicle 2, and then transmits a piece of location data to drive recorder 3.

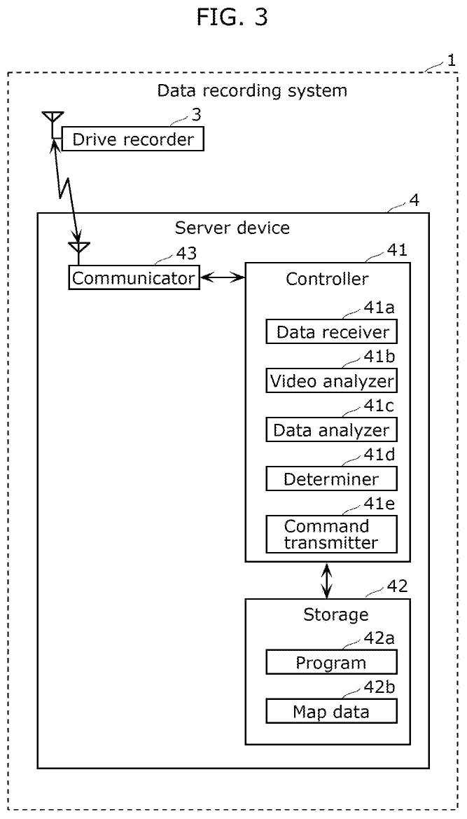

Next, the configuration of server device 4 will be described. FIG. 3 illustrates a configuration of server device 4. Server device 4 is a large-scale arithmetic device provided outside vehicle 2, and is connected with drive recorder 3 via a network. Server device 4 includes controller 41, storage 42, and communicator 43. Note that server device 4 functions as an external device in the present disclosure.

Controller 41 is a computer that includes a CPU, RAM, and ROM. It is desirable for controller 41 to include a plurality of high-performance CPUs etc., since server device 4 is expected to speedily perform large-scale computations. Controller 41 includes data receiver 41a, video analyzer 41b, data analyzer 41c, determiner 41d, and command transmitter 41e. Functions performed by respective units are implemented by controller 41 executing program 42a.

Data receiver 41a receives a status file transmitted from drive recorder 3 via communicator 43.

Video analyzer 41b analyzes what kind of a video is included in a moving image file that is inputted into the status file. Particularly, video analyzer 41b analyzes the presence of a video showing a traffic accident etc. involving vehicle 2. This is because if the video shows an accident caused by vehicle 2 or shows an accident involving vehicle 2, the moving image file is to be stored as a file prohibited from being overwritten. Video analyzer 41b analyzes the moving image file using, for example, a known technique, such as pattern matching. Specifically, video analyzer 41b stores, in advance, pattern images relating to traffic accidents, such as rollover of a vehicle, a fall of a person, breakage of a windshield, and damage to a body of a vehicle, and determines that the moving image file includes a video showing a traffic accident etc. when the moving image file matches a pattern image.

Since the processing load of such image analysis is extremely high, it is desirable for a large-scale arithmetic processing device, such as a server device, to carry out the image analysis. Such a large-scale arithmetic processing device can promptly carry out the analysis. An arithmetic processing device included in a vehicle-mounted drive recorder typically does not have processing power capable of promptly performing such image processing. Accordingly, the use of a server device for carrying out an image analysis of a moving image file that is transmitted from a drive recorder enables prompt and accurate analysis. This also enables processing of prohibiting overwriting of the moving image file to be performed in the drive recorder at an early stage.

Data analyzer 41c analyzes an occurrence happened in vehicle 2, based on pieces of sensor data inputted into the status file. The pieces of sensor data include a G value, a piece of speed data, and a piece of location data of vehicle 2, as described above. Data analyzer 41c analyzes a drastic increase and decrease in a G value and speed, and whether vehicle 2 is situated in a location in which traffic accidents are likely to take place, such as a spot of frequent traffic accidents or an intersection.

Determiner 41d determines whether the moving image file transmitted is to be absolutely prohibited from being overwritten, based on, for example, the degree to which the moving image file matches a pattern image and the magnitude of values of the pieces of sensor data.

When determiner 41d determines that the moving image file is to be absolutely prohibited from being overwritten, command transmitter 41e generates a command (overwrite prohibition command) indicating that drive recorder 3 is to absolutely prohibit overwriting of the corresponding moving image file, and sends the command to drive recorder 3. The command includes the name of the corresponding moving image file and the address of the corresponding moving image file in storage 32. Drive recorder 3 is prevented from performing an incorrect operation by referring to both the file name and the address. Specifically, if the corresponding moving image file is overwritten during a period from drive recorder 3 transmitting a status file to server device 4 to drive recorder 3 receiving an overwrite prohibition command, the moving image file (a moving image file originally not a file to be absolutely prohibited from being overwritten) which is overwritten and recorded would be absolutely prohibited from being overwritten. This causes a problem.

Storage 42 is a storage medium (or recording medium) which stores (or records) data. For example, storage 42 is non-volatile memory, such as electrically erasable programmable read-only memory (EEPROM), flash memory, and a hard disk drive that includes a magnetic disk. Storage unit 42 stores program 42a and map data 42b.

Program 42a is firmware read by controller 41. Controller 41 executes program 42a for controlling server device 4. In addition, program 42a includes software for image processing.

Map data 42b is geographical data about a location and a name of an intersection etc. on a road, a site of a park etc., and a construction such as a building, which are specified by latitude and longitude. Map data 42b includes data about a spot of frequent traffic accidents.

Communicator 43 is a communication device that transmits a piece of data to and receives a piece of data from drive recorder 3 via a network. For example, communicator 43 is a wireless communication device using, for example, worldwide interoperability for microwave access (WiMAX) and long term evolution (LTE).

### [1-3. Moving Image File and Status File]

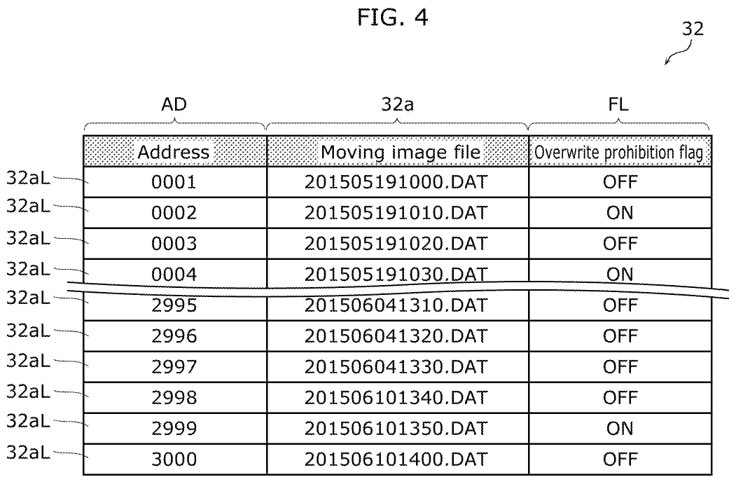

Next, an array structure of a moving image file will be described. FIG. 4 illustrates an array structure of moving image files 32a in storage 32. A recording area in storage unit 32 where moving image files 32a are recorded includes a plurality of records 32aL. The total number of records 32aL is 3000, for example. Each record 32aL includes data areas for address AD, moving image file 32a, and overwrite prohibition flag FL.

Address AD is an identifier indicating a location in the recording area in storage unit 32 where a moving image file is recorded. For example, address AD is indicated by a numerical value, such as “0001” and “0002.”

A single moving image file 32a is recorded in a single record 32aL. Moving image file 32a is given date and time of generation as a file name, and is recorded.

Overwrite prohibition flag FL is an identifier that holds a value for ON or OFF. When overwrite prohibition flag FL is set to ON, moving image file 32a located in record 32aL, which is the same as record 32aL whose overwrite prohibition flag FL is set to ON, is prohibited from being overwritten. When overwrite prohibition flag FL is set to OFF, moving image file 32a in record 32aL, which is the same as the record 32aL whose overwrite prohibition flag FL is set to OFF, is allowed to be overwritten. Note that overwrite prohibition flag FL indicates only ON or OFF. Accordingly, even if overwrite prohibition flag FL is set to ON, it is impossible to determine whether moving image file 32a is absolutely prohibited from being overwritten. Whether moving image file 32a whose overwrite prohibition flag FL is set to ON is absolutely prohibited from being overwritten is identified in overwrite prohibition list 32b (particularly in “overwrite prohibition type”) which will be described later.

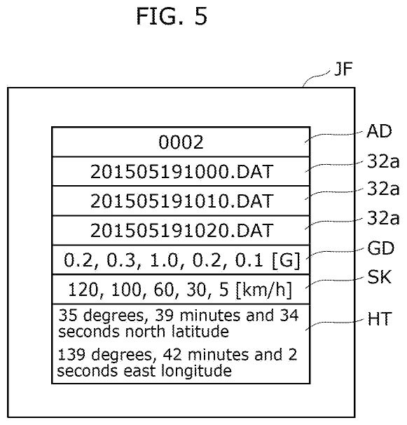

Next, a status file will be described. FIG. 5 illustrates an example of status file JF. Status file JF is a data set including moving image file 32a etc. Status file JF is transmitted to server device 4. Status file JF serves as a factor in determining whether a moving image file is to be absolutely prohibited from being overwritten.

Status file JF includes address AD indicating a location in a recording area in storage 32, three temporally consecutive moving image files 32a, G value GD that is determined to be exceeding threshold Th and G values GD generated within a predetermined period before and after G value GD is determined to be exceeding threshold TH, a plurality of speeds SK recorded within a recording time of moving image file 32a, and latitude and longitude HT which indicates the location of vehicle 2 at the time at which a G value is determined to be exceeding threshold Th. Server device 4 refers to these pieces of data that are transmitted to server device 4. These pieces of data serve as factors in determining whether a moving image file is to be absolutely prohibited from being overwritten. Note that status file JF may include at least one of G value GD, speed SK, and latitude and longitude HT.

### [1-4. Overwrite Prohibition List]

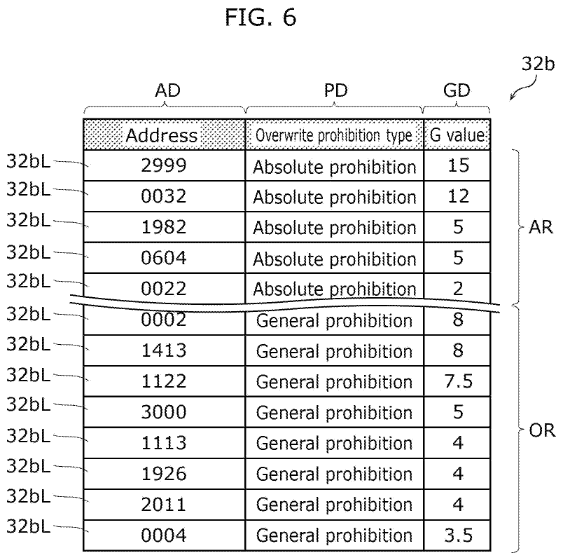

Next, overwrite prohibition list 32b will be described. FIG. 6 illustrates an example of overwrite prohibition list 32b. Overwrite prohibition list 32b is a data table including a plurality of records 32bL. The total number of records 32bL is 100, for example. Each record 32bL includes data areas for address AD, overwrite prohibition type PD, and G value GD.

Address AD is an identifier that indicates the location in a recording area in storage 32 where a moving image file is recorded. For example, address AD is indicated by a numerical value, such as “0001” and “0002.”

Overwrite prohibition type PD indicates a recording mode concerning overwriting of a moving image file to be recorded at address AD in storage 32. The recording mode concerning overwriting includes two types which are “absolute prohibition” and “general prohibition.” Absolute prohibition of overwriting is a recording form that prohibits overwriting of a moving image file by a subsequently generated moving image file even if a situation in which a greater acceleration is generated is captured in the subsequently generated moving image file. General prohibition of overwriting is a recording form that prohibits overwriting of a moving image file by moving image files generated to be cyclically and constantly recorded in storage 32, but allows overwriting of the moving image file by another moving image file in which a situation where a greater acceleration is generated is captured. Record group AR includes records whose overwrite prohibition type PD is designated as absolute prohibition. Note that the number of records in record group AR is, for example, 10. However, the number of records whose overwrite prohibition type PD is designated as absolute prohibition may vary within the range of the total number of records 32bL. Record group OR includes records whose overwrite prohibition type PD is designated as general prohibition. The number of records in record group OR is, for example, 90.

G value GD is a value of acceleration generated in vehicle 2 which is detected by acceleration sensor 23.

### [1-5. Steps]

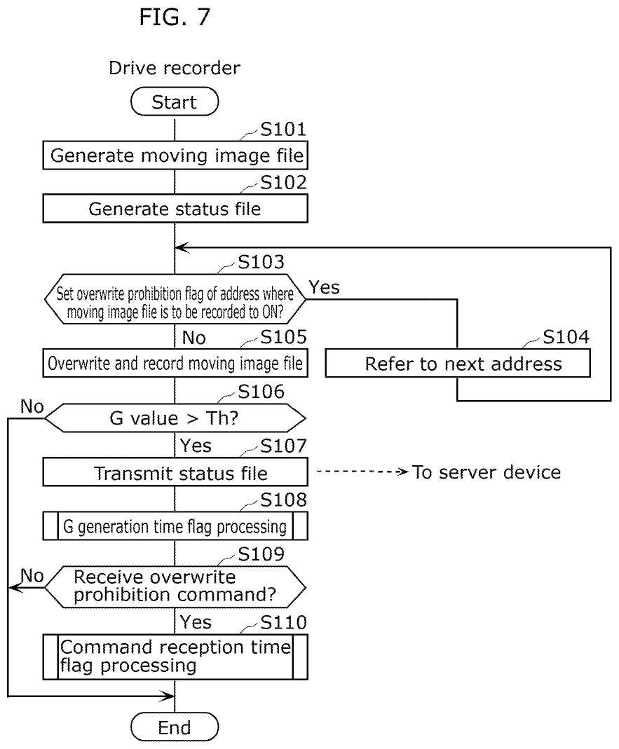

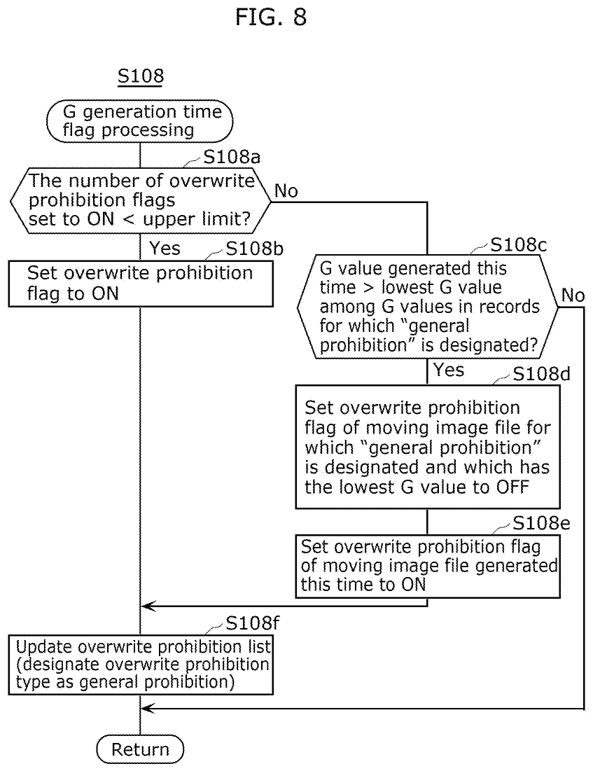

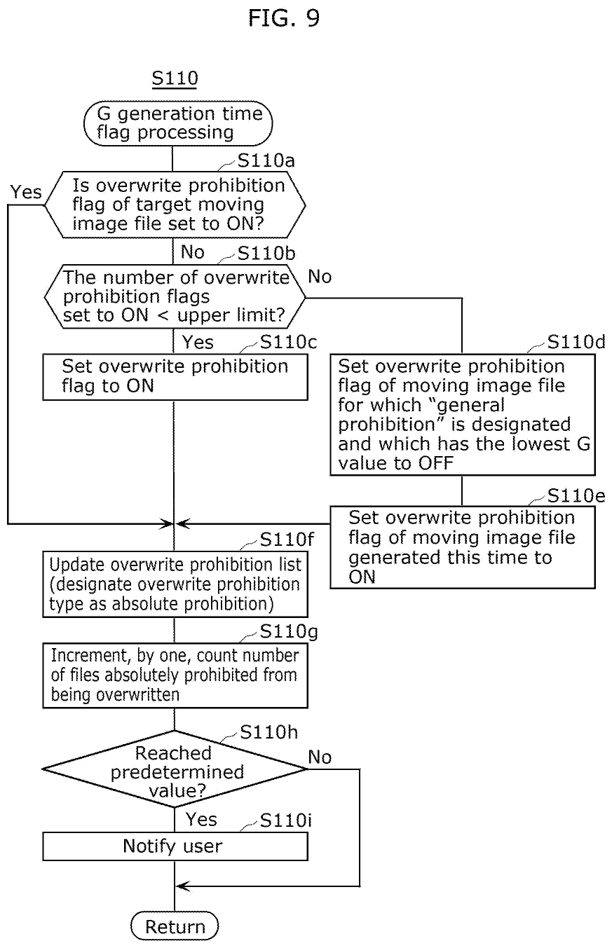

Next, steps of processing performed by drive recorder 3 will be described. FIG. 7, FIG. 8, and FIG. 9 are flowcharts illustrating steps of processing performed by drive recorder 3. Note that the steps of processing are repeatedly performed in a predetermined cycle.

FIG. 7 is a flowchart illustrating main steps of processing performed by drive recorder 3. First of all, data obtainer 31a obtains a plurality of pieces of still image data from camera 22, and generates moving image files (step S101).

Next, data obtainer 31a obtains pieces of acceleration data from acceleration sensor 23, pieces of speed data from speed sensor 24, a piece of location data from location detector 25, and an address, from storage 32, where a moving image file is to be recorded. Then, data obtainer 31a generates a status file that includes the address and the moving image files, and at least one of the pieces of acceleration data, the pieces of speed data, and the piece of location data (step S102).

After data obtainer 31a generates the status file, data recorder 31b refers to the address, in storage 32, where a moving image file generated by data obtainer 31a is to be recorded, and determines whether an overwrite prohibition flag is set to ON (step S103).

After data recorder 31b determines that the overwrite prohibition flag of the referred address is set to ON (Yes in step S103), data recorder 31b refers to a next address (step S104), and determines again whether an overwrite prohibition flag is set to ON (step S103). For example, when the address referred first is 0001, data recorder 31b refers to 0002 as the next address. Data recorder 31b repeatedly performs step S103 and step S104 until data recorder 31b refers to an address whose overwrite prohibition flag is not set to ON, or in other words, until data recorder 31b refers to an address whose overwriting prohibition flag is set to OFF.

Alternatively, when data recorder 31b determines that the overwrite prohibition flag of the referred address is not set to ON (No in step S103), data recorder 31b overwrites a moving image file that has been already recorded with a moving image file generated by data obtainer 31a to be recorded (step S105).

Next, event detector 31c determines whether G values generated in vehicle 2 exceed threshold Th, based on the pieces of acceleration data transmitted from acceleration sensor 23 (step S106).

In other words, event detector 31c determines whether an event that causes prohibition (general prohibition) of overwriting the moving image file has occurred. Threshold value Th is, for example, 0.8 [G].

When event detector 31c determines that the G values do not exceed threshold value Th (No in step S106), the processing ends. So long as the G values do not exceed threshold value Th and an event does not occur, there is no need of performing overwrite prohibition processing.

Alternatively, when event detector 31c determines that a G value exceeds threshold value Th (Yes in step S106), data transmitter 31d transmits the status file generated by data obtainer 31a to server device 4 (step S107). Note that the status file includes, in addition to a moving image file that includes an instant at which the G value exceeds threshold value Th, a moving image file generated temporally before and after the instant at which the G value exceeds threshold value Th. In other words, three moving image files are inputted into the status file. With this, it is possible to carry out a detailed analysis, including a period of time before and after the instant at which the G value exceeds threshold value Th.

After data transmitter 31d transmits the status file to server device 4, G generation time flag processing is performed (step S108). The G generation time flag processing prohibits overwriting of a target moving image file, in the case in which a G value exceeds threshold value Th. The G generation time flag processing will be described later in detail.

When the G generation time flag processing is performed, determination receiver 31e determines whether an overwrite prohibition command is received from server device 4 (step S109).

When determination receiver 31e determines that an overwrite prohibition command is not received from server device 4 (No in step S109), the processing ends.

Alternatively, when determination receiver 31e determines that an overwrite prohibition command is received from server device 4 (Yes in step S109), command reception time flag processing is performed (step S110). The command reception time flag processing absolutely prohibits overwriting of the target moving image file, when the overwrite prohibition command is received from server device 4. The command reception time flag processing will be described later in detail. The processing ends after the command reception time flag processing is performed.

Next, the G generation time flag processing in step S108 will be described in detail. FIG. 8 is a flowchart illustrating steps of processing performed in the G generation time flag processing.

When the G generation time flag processing starts, overwrite prohibitor 31f refers to overwrite prohibition flags FL in storage 32, and determines whether the number of overwrite prohibition flags that are set to ON is less than the upper limit (step S108a). The upper limit is, for example, 100.

When overwrite prohibitor 31f determines that the number of overwrite prohibition flags that are set to ON is less than the upper limit (Yes in step S108a), overwrite prohibitor 31f sets the overwrite prohibition flag of the target moving image file to ON (step S108b).

Alternatively, when overwrite prohibitor 31f determines that the number of overwrite prohibition flags that are set to ON is not less than the upper limit (No in step S108a), overwrite prohibitor 31f determines whether the G value generated this time is greater than the lowest G value among G values in records 32bL whose overwrite prohibition type is designated as “general prohibition” in overwrite prohibition list 32b (step S108c).

When overwrite prohibitor 31f determines that the G value generated this time is not greater than the lowest G value among the G values in records 32bL whose overwrite prohibition type is designated as “general prohibition” (No in S108c), the G generation time flag processing ends, and processing returns to FIG. 7 to perform step S109. So long as the G value generated this time is not greater than (i.e., less than) the G values that have already been recorded, the necessity of prohibiting the target moving image file from being overwritten is low. With this, the limited recording area can be effectively used.

Alternatively, when overwrite prohibitor 31f determines that the G value generated this time is greater than the lowest G value among the G values in records 32bL whose overwrite prohibition type is designated as “general prohibition” (Yes in S108c), overwrite prohibitor 31f sets overwrite prohibition flag FL of record 32aL in storage 32 which has an address same as the address of record 32aL where the lowest G value is recorded to OFF (step S108d).

After setting overwrite prohibition flag FL of the lowest G value to OFF, overwrite prohibitor 31f sets overwrite prohibition flag FL of record 32aL that includes a moving image file generated this time (i.e., moving image file including the instant at which the G value exceeded threshold value Th) to ON (step S108e).

When overwrite prohibitor 31f sets overwrite prohibition flag FL to ON in the above steps S108b and S108e, overwrite prohibitor 31f designates an overwrite prohibition type of the target record 32bL in overwrite prohibition list 32b as “general prohibition” (step S108f). Overwrite prohibitor 31f then updates address AD and G value GD with the address and the G value of the moving image file that generated this time from being overwritten. Note that in the case in which several G values are referred to, the greatest G value is used since the greatest G value clearly displays the occurrence happened in vehicle 2.

After overwrite prohibitor 31f updates overwrite prohibition list 32b, processing returns to FIG. 7 to perform step S109.

By performing the G generation time flag processing, it is possible to prohibit a moving image file including a greater G value from being overwritten, and to effectively use the limited recording area without exceeding the upper limit of the number of moving image files that are prohibited from being overwritten.

Next, the command reception time flag processing in step S110 will be described in detail. FIG. 9 is a flowchart illustrating steps of processing performed in the command reception time flag processing.

When command reception time flag processing is performed, overwrite prohibitor 31f refers to overwrite prohibition flag FL of the target moving file in storage 32, and determines whether the overwrite prohibition flag is set to ON (step S110a). Overwrite prohibitor 31f determines whether the overwrite prohibition flag of the target moving image file is set to ON, since there is a case in which the overwrite prohibition flag of the target moving image file is set to ON at this time. That is, when the G value generated this time is not greater than the other G values in step S108c of the G generation time flag processing (S108), the overwrite prohibition flag of the target moving image file is not set to ON, but is set to OFF. Accordingly, it is necessary for overwrite prohibitor 31f to refer to overwrite prohibition flag FL of the target moving image file in storage 32, and to determine whether the overwrite prohibition flag is set to ON in step S110a.

When overwrite prohibitor 31f determines that the overwrite prohibition flag is set to ON (Yes in step S110a), overwrite prohibitor 31f performs the processing according to step S110f. The processing performed in step S110f will be described later.

Alternatively, when overwrite prohibitor 31f determines that the overwrite prohibition flag is not set to ON (No in step S110a), overwrite prohibitor 31f determines whether the number of overwrite prohibition flags that are set to ON is less than the upper limit (step S110b). The upper limit is, for example, 100.

When overwrite prohibitor 31f determines that the number of overwrite prohibition flags that are set to ON is less than the upper limit (Yes in step S110b), overwrite prohibitor 31f then sets the overwrite prohibition flag of the target moving image file to ON (step S108b). Accordingly, the overwrite prohibition flag of the moving image file that is set to OFF in step S108c of the G generation time flag processing (S108) can be set to ON.

In contrast, overwrite prohibitor 31f sets overwrite prohibition flag FL of record 32aL in storage 32 which has an address same as the address of record 32aL where the lowest G value is recorded among records 32aL and whose overwrite prohibition type is designated as “general prohibition” in overwrite prohibition list 32b to OFF (step S108d). Unlike the above-described G generation time flag processing, whether the G value generated this time is greater than the lowest G value among G values in records 32bL for which “general prohibition” is designated is not determined. So long as server device 4 determines that the target moving image file is to be absolutely prohibited from being overwritten, the target moving image file is to be absolutely prohibited from being overwritten regardless of the magnitude of the G value.

After setting overwrite prohibition flag FL of record 32aL where the lowest G value is recorded to OFF, overwrite prohibitor 31f sets overwrite prohibition flag FL of record 32aL that includes the moving image file generated this time to ON (step S110e).

When overwrite prohibitor 31f determines that the overwrite prohibition flag is set to ON in the above step S110a (Yes in step S110a), and sets the overwrite prohibition flag FL to ON in steps S110c and S110e, overwrite prohibitor 31f designates the overwrite prohibition type of the target record 32bL in overwrite prohibition list 32b as “absolute prohibition” (step S110f). Overwrite prohibitor 31f then updates address AD and G value GD with the address and the G value of the moving image file that is prohibited from being overwritten this time. Note that in the case in which several G values are referred to, the greatest G value is used since the greatest G value clearly displays the occurrence happened in vehicle 2.

After overwrite prohibitor 31f updates overwrite prohibition list 32b, overwrite absolute prohibition counter 31g increments, by one, the count number which overwrite absolute prohibition counter 31g holds (step S110g). In other words, overwrite absolute prohibition counter 31g records that the number of files whose overwrite prohibition type in records 32bL is designated as “absolute prohibition” is increased by one. Next, overwrite absolute prohibition counter 31g determines whether the numerical value that overwrite absolute prohibition counter 31g newly holds as a result of the increment reaches a predetermined numerical value (step S110h).

When the numerical value that overwrite absolute prohibition counter 31g newly holds does not reach the predetermined numerical value (No in step S110h), processing returns to FIG. 7 and ends.

When the numerical value that overwrite absolute prohibition counter 31g newly holds reaches the predetermined numerical value (Yes in step S110h), controller 31 notifies a user that the number of files for which overwrite absolute prohibition is designated has reached a specified number. Processing then returns to FIG. 7 and ends.

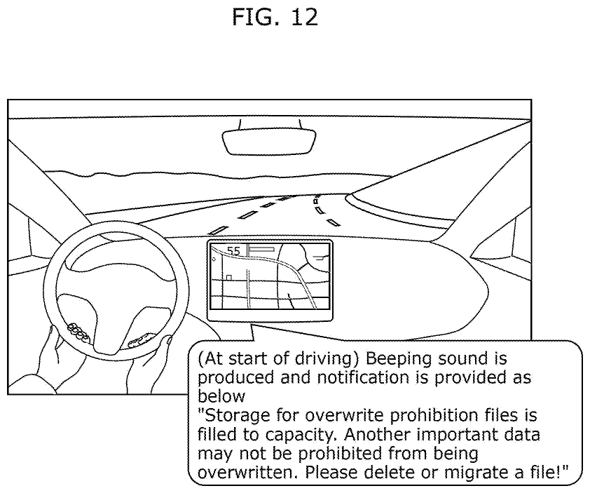

Here, the user may be notified by a sound (or a voice) from a speaker as illustrated in FIG. 12. Besides a sound or a voice, the user may be visually notified (e.g., emission of an LED in the drive recorder and an indication in a display of the drive recorder). In addition, if data is interfaced with a vehicle, an on-vehicle device, such as a steering wheel, may vibrate to notify the user. If the vehicle is interfaced with a device (e.g., a smartphone or a wearable device) owned by the user, the device may be controlled to provide the user with a notification.

Such command reception time flag processing makes it possible to absolutely prohibit a moving image file that is extremely important for a subsequent investigation from being overwritten. When the moving image file is absolutely prohibited from being overwritten, the moving image file will not be overwritten even whatever magnitude of G values is subsequently generated. Therefore, it is possible to effectively store a moving image file that is truly important. Furthermore, since only such moving image file is absolutely prohibited from being overwritten, it is possible to effectively use the limited recording area.

In addition, by counting the number of files that are absolutely prohibited from being overwritten to provide a user with a notification when the number of files has reached a predetermined number, the user can be informed that the storage is reaching capacity due to absolute prohibition of overwriting. With this, it is possible to prevent a moving image file from not being able to be stored when the moving image file is a truly important file to be stored.

(Timing of Providing User with Notification)

Here, the predetermined numerical value set in overwrite absolute prohibition counter 31g may be optionally determined by a user. For example, in the case in which 100 of moving image files that are absolutely prohibited from being overwritten can be recorded, a user may determine the predetermined numerical value to be 100 or 95

In addition, the user need not be notified immediately after the number of moving image files that are absolutely prohibited from being overwritten has reached the predetermined numerical value. The notification may be provided when the user has leeway. For example, the timing at which the user turns off the power source of a drive recorder may be the trigger to provide the user with a notification, or a notification may be provided when shifting of gear of a vehicle into park (P) is detected. Moreover, by interfacing with a navigation device, a notification may be provided when gear is shifted into park (P) on arrival at a destination, such as a home.

By providing a notification when a user has leeway, it is possible to prevent the user from causing an incident, such as a traffic accident.

(Frequency of Providing User with Notification)

It is desirable that the frequency of providing a user with notifications is optionally determined. For example, after providing a user with a notification indicating that the number of moving image files has reached a predetermined numerical value in overwrite absolute prohibition counter 31g, the frequency of providing notifications may be decreased. For example, when the number of moving image files has reached a predetermined numerical value in overwrite absolute prohibition counter 31g, a notification may be provided when the power source of a drive recorder is turned on. In addition, in the case in which the predetermined numerical value is 95 when 100 of moving image files that are absolutely prohibited from being overwritten can be recorded, a notification may be provided again when the number counted by overwrite absolute prohibition counter 31g has reached 100. Alternatively, in the case in which the predetermined numerical value is 95, a notification may be provided each time the number counted by overwrite absolute prohibition counter 31g increases. Moreover, the frequency of providing notifications may be suitably determined by a user.

(Migration of File that is Absolutely Prohibited from being Overwritten)

When the number of moving image files for which overwrite absolute prohibition is designated exceeds a predetermined number, those moving image files for which overwrite absolute prohibition is designated may be transferred (migrated) to another storage area. It is desirable that a portion in storage 32 is allocated in advance for overwrite absolute prohibition file migration area 32d which is an area to which a moving image file for which overwrite absolute prohibition is designated migrates. Alternatively, overwrite absolute prohibition file migration area 32d may be provided in a storage medium different from storage 32. The storage medium different from storage 32 may be externally provided or independently provided inside drive recorder 3.

A moving image file for which overwrite absolute prohibition is designated may be migrated immediately after the number of moving image files for which overwrite absolute prohibition is designated exceeds a predetermined number or when storage capacity reaches its upper limit. For example, in the case in which 100 of moving image files that are absolutely prohibited from being overwritten can be recorded, a moving image file that is absolutely prohibited from being overwritten may be migrated when a counter in overwrite absolute prohibition counter 31g is incremented to 95 or when the counter is incremented to 100.

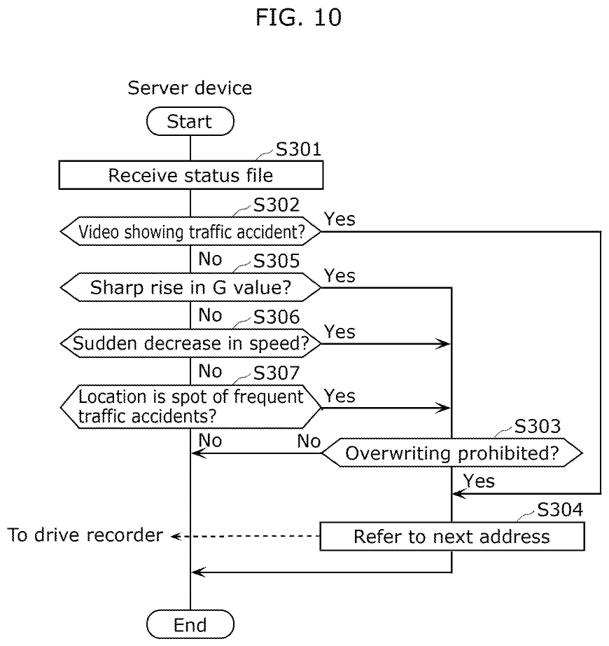

Next, steps of processing performed by server device 4 will be described. FIG. 10 is a flowchart illustrating steps of processing performed by server device 4. Note that the steps of processing are repeatedly performed in a predetermined cycle.

First of all, data receiver 41a receives a status file transmitted from drive recorder 3 (step S301).

After data receiver 41a receives the status file, video analyzer 41b analyzes moving image files included in the status file, and determines whether an image relating to a traffic accident is included (step S302). As has been described above, video analyzer 41b analyzes the moving image files, using, for example, a known technique for image processing, such as pattern matching.

When video analyzer 41b determines that the moving image files include an image relating to a traffic accident etc. (Yes in step S302), command transmitter 41e transmits an overwrite prohibition command to drive recorder 3 (step S304). Accordingly, overwrite prohibition can be designated for a target moving image file. Particularly, it is possible to perform the overwrite absolute prohibition processing. Since a moving image file that includes an image relating to a traffic accident etc. is extremely important for a subsequent investigation, it is desirable to transmit an overwrite absolute prohibition command to drive recorder 3.

Alternatively, when video analyzer 41b determines that the moving image files include an image relating to a traffic accident etc. (No in step S302), data analyzer 41c refers to G values included in the status file, and determines whether there is a sharp rise in the G values (step S305). A sharp rise in a G value likely to indicate harsh braking or a collision. Accordingly, a moving image file is likely to be prohibited from being overwritten. By determining whether there is a sharp rise in a G value, it is possible to prohibit overwriting of a moving image file which is likely to be prohibited from being overwritten, but is excluded from being a target to be prohibited from being overwritten as a result of a video analysis. It should be noted that an analysis of G values, or in other words, an analysis of an amount of change in the G values makes it possible to accurately determine the behavior of vehicle 2, compare to the case in which only the magnitude of a G value is compared with a threshold for determination. Transmission of an overwrite prohibition command causes a moving image file to be absolutely prohibited from being overwritten, therefore the transmission of an overwrite prohibition command should be more carefully determined than merely performing overwrite prohibition processing. However, since the analysis of an amount of change in G values requires large amounts of computations compared to the case in which the magnitude of a G value is compared with a threshold for determination, it is more desirable for a server device which is a large-scale arithmetic device to perform computations than a single on-vehicle device performing the computations. This makes it possible to readily and accurately obtain computation results.

When data analyzer 41c determines that there is a sharp rise in G values (Yes in step S305), determiner 41d refers to a result obtained from the analysis carried out by video analyzer 41b and other pieces of data (speed and/or a location) included in the status file, and determines whether an overwrite prohibition command is to be transmitted to drive recorder 3 (step S303). At this time, determiner 41d refers to the other pieces of data included in the status file, and determines whether an overwrite prohibition command is to be transmitted to drive recorder 3. That is, in addition to the result obtained by determining that the moving image files include an image relating to a traffic accident etc., determiner 41d takes account of a G value, speed, and a location of vehicle 2 to finally determine the necessity of overwrite prohibition command transmission. By taking account of, not only a single piece of data, but a plurality of pieces of data to determine the necessity of overwrite prohibition command transmission, it is possible to prevent prohibition of overwriting a moving image file that is to be prohibited from being overwritten based on one aspect, but not to be prohibited from being overwritten based on variety of aspects, while prohibiting a truly necessary moving image file from being overwritten. With this, it is possible to effectively use the recording area in storage 32. Put another way, video analyzer 41b determining that a moving image file includes an image relating to a traffic accident etc. is merely a trigger to start determining the necessity of overwrite prohibition command transmission. Determiner 41d takes account of the other pieces of data to finally and comprehensively determine the necessity of overwrite prohibition command transmission. Note that determiner 41d is to be separately provided with determination criteria based on the plurality of pieces of data. The determination criteria include, in addition to the inclusion of an image relating to a traffic accident etc. in a moving image file, a G value of at least 1.5 [G], a speed of at least 80 [km/h], and a location indicating an intersection etc.

When determiner 41d determines that an overwrite prohibition command is to be transmitted to drive recorder 3 (Yes in step S303), command transmitter 41e transmits an overwrite prohibition command (step S304). Alternatively, when determiner 41d determines that an overwrite prohibition command is not to be transmitted to drive recorder 3 (No in step S303), an overwrite prohibition command is not transmitted to drive recorder 3, and the processing ends.

When data analyzer 41c determines that there is no sharp rise in G values in step S305 (No in step S305), data analyzer 41c determines whether there is a sudden decrease in speed (step S306). Like a sharp rise in G values, a sudden decrease in speed likely to indicate harsh braking or a collision. Accordingly, the moving image file is likely to be prohibited from being overwritten. By determining whether there is a sudden decrease in speed, it is possible to prohibit overwriting of a moving image file which is likely to be prohibited from being overwritten, but is excluded from being a target to be prohibited from being overwritten as a result of the video analysis and the G value analysis.

When data analyzer 41c determines that there is a sudden decrease in speed (Yes in step S306), determiner 41d refers to a result obtained from an analysis carried out by video analyzer 41b and other pieces of data (G values and/or a location) included in the status file, and determines whether an overwrite prohibition command is to be transmitted to drive recorder 3 (step S303). The reasons for referring to the analysis result and the other pieces of data are as described above.

When determiner 41d determines that an overwrite prohibition command is to be transmitted (Yes in step S303), command transmitter 41e transmits an overwrite prohibition command (step S304), and when determiner 41d determines that an overwrite prohibition command is not to be transmitted (No in step S303), the processing ends.

When data analyzer 41c determines that there is no sudden decrease in speed in step S306 (No in step S306), data analyzer 41c determines whether a location of vehicle 2 is an intersection, a spot of frequent traffic accidents, etc. (step S307). When the location of vehicle 2 is an intersection, a spot of frequent traffic accidents, etc., it is likely that vehicle 2 is involved in an accident. Accordingly, the moving image file is likely to be prohibited from being overwritten. By determining whether the location of vehicle is an intersection, a spot of frequent traffic accidents, etc., it is possible to prohibit overwriting of a moving image file that is likely to be prohibited from being overwritten, but is excluded from being a target to be prohibited from being overwritten as a result of the video analysis, the G value analysis, and the speed analysis. Data analyzer 41c determines whether the location of vehicle 2 is an intersection, a spot of frequent traffic accidents, etc. by referring to latitude and longitude at which vehicle 2 locates, and map data 42b from the status file.

When data analyzer 41c determines that the location of vehicle 2 is a spot of frequent traffic accidents (Yes in step S307), determiner 41d refers to a result obtained from an analysis carried out by video analyzer 41b and other pieces of data (G values and/or speed) included in the status file, and determines whether an overwrite prohibition command is to be transmitted to drive recorder 3 (step S303). The reasons for referring to the analysis result and the other pieces of data are as described above.

When determiner 41d determines that an overwrite prohibition command is to be transmitted (Yes in step S303), command transmitter 41e transmits an overwrite prohibition command (step S304), and when determiner 41d determines that an overwrite prohibition command is not to be transmitted (No in step S303), the processing ends.

When data analyzer 41c determines that the location of vehicle 2 is neither an intersection nor a spot of frequent traffic accidents in step S307 (No in step S307), the processing ends.

As such, it is desirable to determine whether a moving image file is to be prohibited from being overwritten, not based on a single piece of data, but based on a plurality of pieces of data, particularly for determining whether a moving image file is to be absolutely prohibited from being overwritten. Furthermore, it is desirable to determine whether a moving image file is to be prohibited from being overwritten using, not a comparison of the magnitude of data to a threshold, but time course of data. Since overwriting would not be allowed in the recording area in storage 32 when absolute prohibition of overwriting is implemented, it requires prudent determination. Moreover, since the determination based on a plurality of pieces of data and time course of data requires large amounts of computations, it is more desirable for a server device which is a large-scale arithmetic device to perform computations than a single on-vehicle device performing the computations.

As has been described above, drive recorder 3 according to the embodiment transmits, to server device 4, moving image files that show the status of surroundings of vehicle 2 at the time of generation of a large acceleration. Server device 4 determines whether overwrite prohibition is to be designated for a moving image file, based on the moving image files that show surroundings of vehicle 2 at the time of and/or before and after the occurrence of an event. Then, based on the determination result, drive recorder 3 designates overwrite prohibition for the piece of video data that shows surroundings at the time of and/or before and after the occurrence of the event. Accordingly, it is possible to prohibit overwriting of a piece of video data that is to be prohibited from being overwritten, and to allow a piece of video data that is not to be necessarily prohibited from being overwritten to be overwritten. With this, the storage area (storage capacity) can be effectively used.

In addition, the status data transmitted to server device 4 includes at least one piece of acceleration data, speed data, and location data generated in vehicle 2 at the time of and/or before and after an occurrence of an event. By server device 4 analyzing the behavior of vehicle 2, it is possible to improve the accuracy of determining whether the moving image file is to be prohibited from being overwritten.

In addition, the status data transmitted to server device 4 includes moving image files. With this, it is possible for server device 4 to determine whether a moving image file is to be prohibited from being overwritten by directly analyzing videos. Since a moving image that is to be prohibited from being overwritten can be directly analyzed, it is possible to reliably implement prohibition of overwriting.

### [2. Variation]

The embodiment of the present disclosure has been described as above. However, the present disclosure is not limited to the above-described embodiment. The present disclosure can be variously modified. Hereinafter, a variation will be described. All embodiments including the embodiment described above and the following embodiment can be suitably combined.

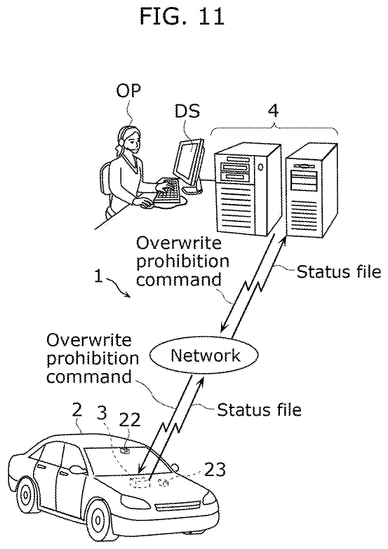

In the above-described embodiment, server device 4 determines whether a moving image file is to be prohibited from being overwritten by performing image processing, such as pattern matching, on the moving image file included in a status file transmitted from the drive recorder. However, server device 4 need not determine whether a moving image file is to be prohibited from being overwritten. Whether a moving image file is to be prohibited from being overwritten may be determined by a person visually identifying a moving image (or still images). FIG. 11 illustrates a variation of the data recording system. A moving image file received by server device 4 from a drive recorder is displayed on display screen DS, and operator OP of server device 4 visually identifies the moving image (or the still images) to determine whether the moving image file is to be prohibited from being overwritten. Since the status of a traffic accident etc. can be carefully examined based on experience learned by a person and sensitivity which a person has in this case, it is possible to improve the accuracy of determining whether the moving image file is to be prohibited from being overwritten, compare to the case in which the prohibition of overwriting is determined by performing mechanical processing, such as pattern matching.

In the above-described embodiment, a moving image file that includes the instant of generation of a G value is prohibited from being overwritten. However, moving image files generated temporally before and after the generation of a moving image file that includes the instant of generation of a G value may also be prohibited from being overwritten. This makes it possible to readily analyze a factor for the generation of a G value, even if the instant at which the G value generated is immediately after the start of the moving image file, or immediately before the end of the moving image file.

In addition, the generation of acceleration is described as a trigger to prohibit overwriting of a moving image file in the above-described embodiment, but a change in speed may be a trigger. A trigger may be any occurrences of events.

In addition, a G value that is greater than threshold Th is described as a condition for an occurrence of an event in the above-described embodiment. However, an occurrence of other events may be determined as the condition, instead of a G value. For example, a switch may be provided, and a switch operation performed by a user may be a condition for an occurrence of an event. In this case, a user can control the occurrence of an event.

In addition, in the above-described embodiment, a moving image file for which the necessity of overwrite prohibition is to be determined is selected in drive recorder 3. However, a moving image file for which the necessity of overwrite prohibition is to be determined may be selected in server device 4. In this case, drive recorder 3 transmits all of moving image files generated to server device 4.

In addition, in the above-described embodiment, a file that is to be prohibited from being overwritten is determined in server device 4 provided outside a vehicle, but a file that is to be prohibited from being overwritten need not be determined in server device 4. A file that is to be prohibited from being overwritten may be determined in a device provided inside a vehicle. For example, the device may be a navigation device. However, it is desirable that the device includes a central processing unit (CPU) which has relatively high computation processing power since image processing etc. require large amounts of computations. If image processing etc. are performed in an interval of computations or performed using reserve power of such CPU, control of navigation etc. would not be interfered.

In addition, although pieces of acceleration data obtained by the acceleration sensor are used in the above-described embodiment, pieces of data obtained from periphery surveillance sensors, such as a millimeter-wave radar, an infrared-ray radar, and clearance sonar, motion control sensors, such as a brake sensor, an accelerator opening sensor, and a shift sensor, and safety control sensors, such as an air bag, a seat belt, and a door lock may be used.

In addition, although the status file in the above-described embodiment includes moving image files, and pieces of data about acceleration, speed, and a location, the status file may include pieces of data other than the aforementioned pieces of data. That is, the status file may include engine speed, a distance traveled this time, the number and the weight of items of baggage, the number of passengers (travelers) in the same vehicle, etc. By taking the distance traveled this time into account, it is possible to measure the degree of fatigue experienced by a driver. By referring to the number and the weight of items of baggage, it is possible to measure the degree of traveling stability of a vehicle.

In addition, a mobile body is described as a vehicle, such as a car, in the above-described embodiment. However, the mobile body may be other vehicles, such as an airplane, a vessel, and rolling stock. The mobile body may be an unmanned mobile body on which no person boards.

In addition, the function described as one block in the above-described embodiment need not be carried out by a single physical element. The function may be carried out by distributed physical elements. In addition, the function described as a plurality of blocks in the above-described embodiment may be carried out by a single physical element. Moreover, devices inside a vehicle and devices outside the vehicle may share processing to be performed for one optional function, and may communicate with one another to share information. With this, the one function may be carried out as a whole.

In addition, although all or some of the above-described functions are carried out through software by executing a program in the above-described embodiment, all or some of the functions may be carried out by electric hardware circuitry. In contrast, all or some of the above-described functions that are carried out by hardware circuitry may be carried out through software. In addition, a function described as one block in the above-described embodiment may be carried out using both software and hardware.

While the foregoing has described the drive recorder according to one or more aspects of the present disclosure based on the embodiments, the present disclosure is not limited to these embodiments. Various modifications to these embodiments conceivable to those skilled in the art, as well as embodiments resulting from combinations of structural elements in different embodiments may be included within the scope of one or more aspects of the present disclosure, so long as they do not depart from the essence of the present disclosure.

Further Information about Technical Background to this Application

The disclosures of the following Japanese Patent Application including specification, drawings and claims are incorporated herein by reference in its entirety: Japanese Patent Application No. 2020-012141 filed on Jan. 29, 2020.

### INDUSTRIAL APPLICABILITY

The present disclosure is applicable to a drive recorder.

1. A drive recorder that records, in a temporally continuous manner, a piece of video data showing surroundings of a vehicle on a recording medium, the drive recorder comprising:
an obtaining means for obtaining the piece of video data;
a recording means for recording a new piece of video data on the recording medium by overwriting, with the new piece of video data, an other piece of video data among a plurality of pieces of video data which have been recorded on the recording medium, the other piece of video data being data for which overwrite prohibition is not designated;
a detecting means for detecting an occurrence of an event;
a transmitting means for transmitting, to an external device, a piece of status data indicating status at a time of and/or before and after the occurrence of the event;
a receiving means for receiving, from the external device, a determination result obtained by the external device determining, based on the piece of status data, whether the overwrite prohibition is designated for a piece of event video data, the piece of event video data being the piece of video data showing surroundings of the vehicle at the time of and/or before and after the occurrence of the event;
a prohibiting means for designating, based on the determination result, the overwrite prohibition for the piece of event video data; and
a counting means for counting a total number of pieces of event video data for which overwrite prohibition is designated by the prohibiting means.

2. The drive recorder according to claim 1, further comprising:
a notifying means for providing a user with a notification when the total number counted by the counting means exceeds a predetermined threshold.

3. The drive recorder according to claim 2, wherein
the notifying means provides the user with a notification when the total number counted exceeds the predetermined threshold and a predetermined condition is satisfied.

4. The drive recorder according to claim 3, wherein
after providing the user with the notification, the notifying means provides the user with another notification when a predetermined condition specified subsequent to the predetermined condition is satisfied.

5. The drive recorder according to claim 1, further comprising:
a data migrating means for transferring a piece of event video data for which the overwrite prohibition is designated from a recording area in which the piece of event video data is recorded to a different recording area, when the total number counted by the counting means reaches a certain number.

6. A drive recorder that records, in a temporally continuous manner, a piece of video data showing surroundings of a vehicle on a recording medium, the drive recorder comprising:
an obtaining means for obtaining the piece of video data;
a recording means for recording a new piece of video data on the recording medium by overwriting, with the new piece of video data, an other piece of video data among a plurality of pieces of video data which have been recorded on the recording medium, the other piece of video data being data for which overwrite prohibition is not designated;
a detecting means for detecting an occurrence of an event;
a transmitting means for transmitting, to an external device, a piece of status data indicating status at a time of and/or before and after the occurrence of the event;
a receiving means for receiving, from the external device, a determination result obtained by the external device determining, based on the piece of status data, whether the overwrite prohibition is designated for a piece of event video data, the piece of event video data being the piece of video data showing surroundings of the vehicle at the time of and/or before and after the occurrence of the event;
a prohibiting means for designating, based on the determination result, the overwrite prohibition for the piece of event video data; and
a notifying means for providing a user with a notification when a total number of pieces of event video data for which overwrite prohibition is designated by the prohibiting means exceeds a predetermined threshold.

7. A data recording method for recording, in a temporally continuous manner, a piece of video data showing surroundings of a vehicle on a recording medium, the data recording method comprising:
(a) obtaining the piece of video data;
(b) recording a new piece of video data obtained in (a) on the recording medium by overwriting, with the new piece of video data, an other piece of video data among a plurality of pieces of video data which have been recorded on the recording medium, the other piece of video data being data for which overwrite prohibition is not designated;
(c) detecting an occurrence of an event;
(d) transmitting, to an external device, a piece of status data indicating status at a time of and/or before and after the occurrence of the event;
(e) receiving, from the external device, a determination result obtained by the external device determining, based on the piece of status data, whether the overwrite prohibition is designated for a piece of event video data, the piece of event video data being the piece of video data showing surroundings of the vehicle at the time of and/or before and after the occurrence of the event;
(f) designating, based on the determination result, overwrite prohibition for the piece of event video data; and
(g) counting a total number of pieces of event video data for which overwrite prohibition is designated in the designating.
